(19) United States
(12) Patent Application Publication
(10) Pub. No.: US 2024/0175985 A1
(43) Pub. Date: May 30, 2024

(54) LIDAR SENSOR WITH WINDOW BREAKAGE DETECTION

(71) Applicant: Continental Autonomous Mobility US, LLC, Auburn Hills, MI (US)

(72) Inventors: Jose Miguel Banuelos Carrillo, Ventura, CA (US); Benjamin Gordon, Ventura, CA (US); Octavio Samano Cancino, Oxnard, CA (US)

(73) Assignee: Continental Autonomous Mobility US, LLC, Auburn Hills, MI (US)

(21) Appl. No.: 18/060,442

(22) Filed: Nov. 30, 2022

(51) Int. Cl. G01S 7/481; G01L 1/22; G01S 7/497

(52) U.S. Cl. CPC G01S 7/4813; G01L 1/2206; G01L 1/2287; G01S 7/497; G01S 2007/4975

(57) ABSTRACT

A lidar sensor assembly includes a housing having a window. A light source is disposed within the housing and configured to generate light which is directed through the window. A detector array is disposed within the housing and configured to detect light generated by the light source and reflected off at least one object. A controller is in communication with the light source to control operation of the light source. A strain gauge is in communication with the controller and includes a conductive element disposed on the window. The controller is configured to deactivate the light source in response to the strain gauge indicating damage to said window.

### TECHNICAL FIELD

The technical field relates generally to lidar sensors and more particularly to detecting breaking in a window of a lidar sensor.

### BACKGROUND

Lidar sensors may generate laser light which can be harmful to the eyes of humans or other animals. A laser generating the laser light is typically disposed within a housing, behind a window. The window may include a filter to prevent harmful emissions of laser light (i.e., light at certain wavelengths) from escaping the housing and into the environment. However, should this window become broken, harmful emissions of laser light may be dispersed.

As such, it is desirable to present a system and/or method to detect breakage of a window in a lidar sensor. In addition, other desirable features and characteristics will become apparent from the subsequent summary and detailed description, and the appended claims, taken in conjunction with the accompanying drawings and this background.

### BRIEF SUMMARY

In one exemplary embodiment, a lidar sensor assembly includes a housing having a window. A light source is disposed within the housing and configured to generate light which is directed through the window. A detector array is disposed within the housing and configured to detect light generated by the light source and reflected off at least one object. A controller is in communication with the light source to control operation of the light source. A strain gauge is in communication with the controller and includes a conductive element disposed on the window. The controller is configured to deactivate the light source in response to the strain gauge indicating damage to said window.

In another embodiment, a method of detecting damage to a window of lidar sensor assembly is described. The lidar sensor assembly includes a housing defining an opening, the window disposed in the opening, a light source disposed within the housing and configured to generate light which is directed through the window, and a detector array disposed within the housing and configured to detect light generated by the light source and reflected off at least one object. The method includes disposing a conductive element disposed on the window. The method further includes sensing a resistance of the conductive element as part of a strain gauge. The method also includes determining whether damage has occurred to the window based on the sensed resistance of the conductive element.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a side view of a vehicle equipped with a plurality of lidar sensor assemblies;

FIG. 2 is a cross-sectional block diagram of a lidar sensor assembly;

FIG. 3 is a top-view of a conductive trace on a window of the Lidar sensor assembly and electrical schematic connection to a Whetstone Bridge;

FIG. 4 is a cross-sectional view of the window along the line 4-4 in FIG. 3; and

FIG. 5 is flowchart of a method of detecting damage to a window of lidar sensor assembly.

### DETAILED DESCRIPTION

Referring to the Figures, wherein like numerals indicate like parts throughout the several views, a lidar sensor assembly 100 is shown and described herein.

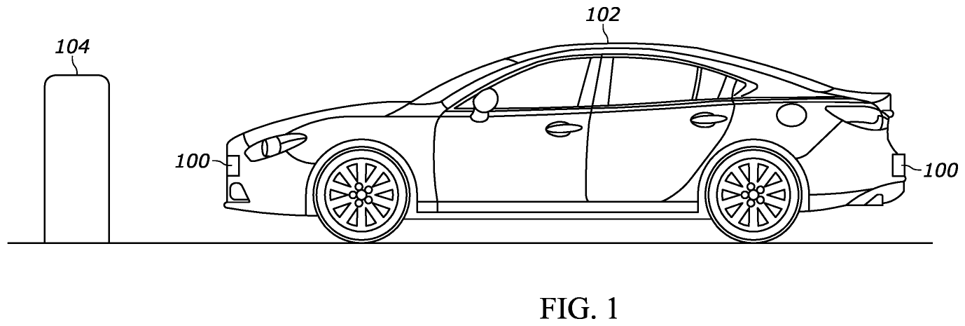

FIG. 1 is a side view of an example vehicle 102 and an object 104. The vehicle 102 shown in FIG. 1 is a passenger automobile supporting a plurality of lidar sensor assemblies 100. However, as other examples, the vehicle 102 may be of any suitable manned or unmanned vehicle including a truck, motorcycle, plane, satellite, drone, watercraft, robot, etc. The object 104 may be a moving or stationary object such as another vehicle, pedestrian, vegetation, building, etc., located outside the vehicle 102.

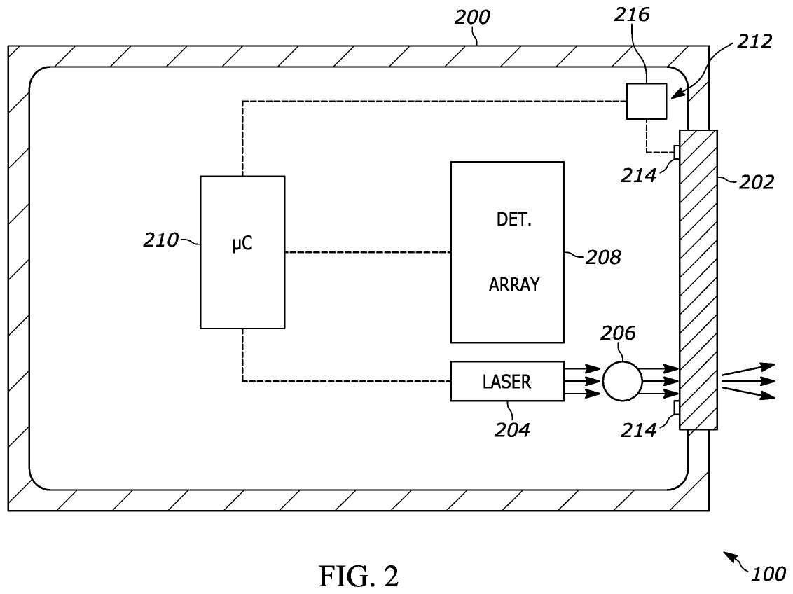

Referring now to FIG. 2, the lidar sensor assembly 100 includes a housing 200. The housing 200 may be formed of any suitable material, e.g., plastic, metal, fiberglass, or the like.

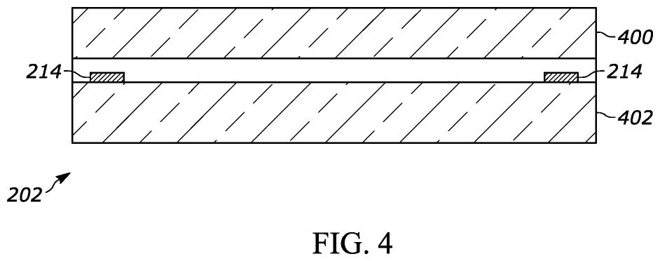

The housing 200 includes a window 202 allowing light to exit and enter the housing. In the illustrated embodiment, as shown in FIG. 4, the window 202 includes a first pane 400 and a second pane 402. The panes 400, 402 may be formed of glass, plastic, or other suitable material, as appreciated by those of ordinary skill in the art. The window 202 of the illustrated embodiment also includes a layer 404 of polyvinyl butyral (“PVB”) sandwiched between the first pane 400 and the second pane 402. The PVB layer 404 acts as an adhesive to hold the panes 400, 402 of the window 202 together in case one or both of the panes 400, 402 become cracked. It should be appreciated that in other embodiments the window 202 may include additional or fewer panes.

Referring again to FIG. 2, the lidar sensor assembly 100 includes a light source 204 disposed within the housing 200. The light source 204 is configured to generate light which is directed through the window 202. In some embodiments, the light source 204 is a laser, particularly a diode pumped Q-switch laser generating a wavelength of about 1064 nm.

The window 202 may also include a filter (not shown) designed to prevent potentially harmful emissions of light from escaping from the housing 200 and into the environment outside of the lidar sensor assembly 100.

The lidar sensor assembly 100 may also include optics 206 configured to focus, disperse, and/or otherwise condition the light generated by the light source 204, as is readily appreciated by those of ordinary skill in the art. The lidar sensor assembly 100 may also include a beam steering mechanism (not shown) configured to route the light generated by the light source 204 in a particular direction through the window 202.

The lidar sensor assembly 100 further includes a detector array 208 disposed within the housing 200. The detector array 208 includes a plurality of light-sensitive photodetectors (not individually shown). The detector array 208 is configured to detect light generated by the light source 204 and reflected off at least one object 104.

The lidar sensor assembly 100 also includes a controller 210. The controller 210 may be a microprocessor, microcontroller, application specific integrated circuit (“ASIC”), and/or any other device configured to perform calculations and/or execute instructions (i.e, run a program). The controller 210 is shown in FIG. 2 as being disposed within the housing 200. However, it should be appreciated that the controller 210 may be disposed at other locations, e.g., outside of the housing 200. Further, the controller 210 may be part of a separate processing system (not shown), for example, providing control over multiple lidar sensor assemblies 100 and/or other systems of the vehicle 102.

The controller 210 is in communication with the light source 204 to control operation of the light source 204. That is, the controller 210 may control when and if the light source 204 generates light. The controller 210 may also prohibit the light source 204 from generating light.

The lidar sensor assembly 100 includes a strain gauge 212 configured to detect potential damage to the window 202. The strain gauge 212 is configured to measure strain on the window 202 to determine if the window 202 is broken, cracked, and/or otherwise damaged.

The strain gauge 212 is in communication with the controller 210, such that the controller 210 may realize the state (broken, cracked, normal, etc.) of the window 202. The strain gauge includes a conductive element 214 disposed on the window 202 and an electronic component portion 216. The conductive element 214 may be implemented as a wire, conductive paint, or other suitable material as appreciated by those of ordinary skill in the art.

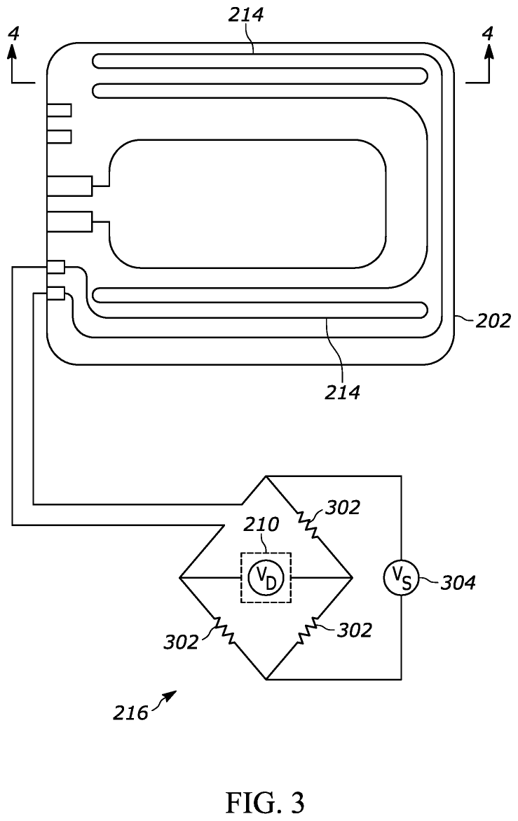

As shown in the embodiment of FIG. 3, the electronic component portion includes a Wheatstone bridge 300. The Wheatstone bridge 300 includes three resistors 302 each having a known value, while the conductive element 214 provides a measurable resistance that corresponds to the strain placed on the window 202. A voltage source 304 is electrically connected to the Wheatstone bridge 300 to provide a reference voltage to the resistors 302 and the conductive element 214. The controller 210 is also electrically connected to the Whetstone bridge 300 and is configured to sense changes in the resistance of the conductive element 314. As stated above, the controller 210 is then able to determine the state of the window 202 based on this sensed resistance. For instance, the controller may compare the sensed resistance may be compared to a predetermined resistance to determine whether damage has occurred to the window.

Referring again to FIG. 4, the conductive element 214 is sandwiched between the panes 400, 402. In other embodiments, the positioning of the conductive element 214 may be different. For example, the conductive element 214 may be touching the pane 400, 402 facing the interior of the housing 200.

Referring again to FIG. 2, the controller 210 is configured to deactivate the light source 204 in response to the strain gauge 212 indicating damage to the window 202. As such, if some damage were to occur to the window 202, the light source 204 would be deactivated to protect the eyes of people in the vicinity of the vehicle 102 from potentially harmful emissions.

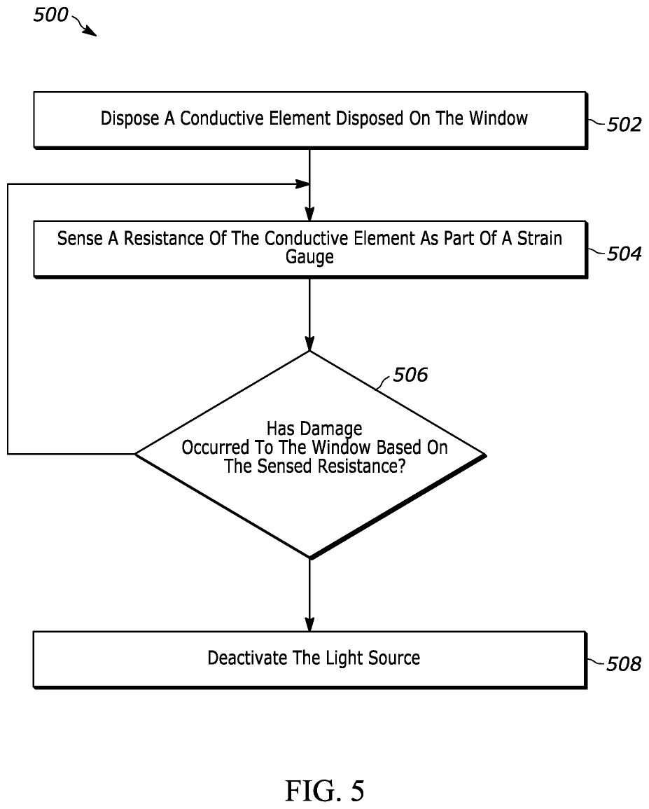

Referring now to FIG. 5, a method 500 of detecting damage to a window 202 of lidar sensor assembly 100 is presented. The method 500 includes, at 502, disposing a conductive element 214 on the window 202. The method 500 also includes, at 504, sensing a resistance of the conductive element 214 as part of a strain gauge 216. Sensing the resistance of the conductive element may occur over time.

The method 500 further includes, at 506, determining whether damage has occurred to the window 202 based on the sensed resistance of the conductive element 214. If no damage has occurred, then the analysis at 504, 506 repeats. If damage to the window 202 has occurred, then the method 500 continues, at 508, with deactivating the light source 204.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly comprising:
a housing having a window;
a light source disposed within said housing and configured to generate light which is directed through said window;
a detector array disposed within said housing and configured to detect light generated by said light source and reflected off at least one object; and
a controller in communication with said light source to control operation of said light source; and
a strain gauge in communication with said controller and including a conductive element disposed on said window;
said controller configured to deactivate said light source in response to said strain gauge indicating damage to said window.

2. The lidar sensor assembly as set forth in claim 1 wherein said window includes a first pane and a second pane and wherein said conductive element is sandwiched between said first pane and said second pane.

3. The lidar sensor assembly as set forth in claim 2 wherein said window further includes polyvinyl butyral sandwiched between said first pane and said second pane.

4. The lidar sensor assembly as set forth in claim 2 wherein said first pane and said second pane are formed of glass.

5. The lidar sensor assembly as set forth in claim 1 wherein said strain gauge further includes a Wheatstone bridge electrically connected to said conductive element.

6. The lidar sensor assembly as set forth in claim 1 wherein said strain gauge is configured to sense a resistance of the conductive element.

7. The lidar sensor assembly as set forth in claim 6 wherein said controller is configured to compare the sensed resistance to a predetermined resistance to determine whether damage has occurred to said window.

8. A method of detecting damage to a window of lidar sensor assembly, wherein the lidar sensor assembly includes a housing defining an opening, the window disposed in the opening, a light source disposed within the housing and configured to generate light which is directed through the window, a detector array disposed within the housing and configured to detect light generated by the light source and reflected off at least one object, said method comprising:
disposing a conductive element disposed on the window;
sensing a resistance of the conductive element as part of a strain gauge; and
determining whether damage has occurred to the window based on the sensed resistance of the conductive element.

9. The method as set forth in claim 8 further comprising deactivating said light source in response to said strain gauge indicating damage to said window.

10. The method as set forth in claim 8 wherein sensing the resistance of the conductive element is further defined as sensing the resistance of the conductive element over time.
